(19) United States
(12) Patent Application Publication
(10) Pub. No.: US 2007/0180729 A1
(43) Pub. Date: Aug. 9, 2007

(54) Blow box apparatus

(76) Inventor: Paul A. Girolamo, Clinton, WI (US)

Correspondence Address: DAVID J. ARCHER, 7037 POMERY ROAD, ROCKTON, IL, 61072, US

(21) Appl. No.: 11/698,791

(22) Filed: Jan. 26, 2007

Related U.S. Application Data
(60) Provisional application No. 60/762,288, filed on Jan. 26, 2006.

(51) Int. Cl. F26B 3/00

(52) U.S. Cl. 34/455; 34/456

(57) ABSTRACT

A blow box apparatus is disposed within a pocket defined between an upstream and a downstream dryer and a transfer roll. The blow box apparatus includes an elongate box which defines an enclosure in which the first and the second ends of the enclosure are connected to a source of pressurized air. A first end wall has a proximal and a distal end and a first and a second edge. The proximal end is secured to the first end of the enclosure and the distal end is disposed adjacent to the transfer roll. The first edge is disposed adjacent to the upstream dryer and the second edge is disposed adjacent to the downstream dryer. A baffle is disposed between the end walls such that during a threading operation, a tail of the web is guided around the upstream dryer and around a threading chamber of the transfer roll.

### CROSS REFERENCE TO RELATED APPLICATION

The present application is a Complete application pursuant to Provisional application U.S. Ser. No. 60/762,288 filed Jan. 26, 2006. All the disclosure of the aforementioned application is incorporated herein by reference.

### BACKGROUND OF THE INVENTION

1. Field of the Invention

The present invention relates to a blow box apparatus.

More specifically, the present invention relates to a blow box apparatus which is disposed within a pocket defined between an upstream and a downstream dryer and a transfer roll.

2. Background Information

In the paper making art, when a web has been pressed, such web is guided around a plurality of drying cylinders for removing most of the remaining moisture from the pressed web.

Many drying cylinders are arranged in groups of dryers with a rotatable transfer roll disposed between adjacent drying cylinders. A drying felt extends in a sinusoidal path around an upstream dryer to a transfer roll and around a downstream dryer. The web to be dried is disposed between the drying felt and the heated surface of the upstream dryer. However, the drying felt is disposed between the web and the outer surface of the transfer roll as the web extends around and is guided by the transfer roll. Also, the web is disposed between the drying felt and the heated surface of the downstream dryer as the web extends around the downstream dryer.

During a threading operation, a tail cutter cuts the web in a machine direction so that a tail approximately 6 inches in width is generated adjacent to a front side of the drying section. The forward end of the tail is threaded around an upstream dryer, an adjacent transfer roll and then around an adjacent downstream dryer. The remainder of the width of the web is returned to the broke pit as the forward end of the tail is progressively threaded along the drying section or group and onto succeeding drying sections.

As the tail extends around the transfer roll, high vacuum is applied to a threading chamber defined within the front end of the transfer roll. The high vacuum pulls the tail into close conformity with the drying felt as the tail and felt extend around the transfer roll adjacent to the threading chamber.

However, in order to reduce edge flutter during high speed operation of a drying section, a blow box is provided immediately adjacent to the transfer roll, the blow box being disposed between the upstream and downstream dryer. Prior art blow boxes have permitted dissipation of the high vacuum from the sector of the threading chamber of the transfer roll not covered by the drying felt and the tail of the web extending around the transfer roll. Accordingly, in the prior art, it has been necessary to apply an extremely high vacuum to the threading chamber in order to compensate for such dissipation of vacuum above the threading chamber through the blow box during a threading operation.

The present invention overcomes the aforementioned problem by isolating the cavity immediately above the threading chamber by a baffle disposed within the blow box so that the vacuum within the threading chamber is not dissipated across the entire cross machine direction width of the blow box chamber.

Nevertheless, according to the arrangement of the apparatus according to the present invention, when the threading operation has been completed and the tail has been widened to a full width of the web, the vacuum generated within the pocket by the blow box apparatus is effective in reducing edge flutter of the web.

Therefore, it is a primary feature of the present invention to provide a blow box apparatus that overcomes the problems associated with the prior art arrangements.

Another feature of the present invention is the provision of a blow box apparatus that inhibits dissipation of vacuum from a threading chamber of a vacuum transfer roll during automatic threading of a tail of a web.

Other features and advantages of the present invention will be readily apparent to those skilled in the art by a consideration of the detailed description of a preferred embodiment of the present invention contained herein.

### SUMMARY OF THE INVENTION

The present invention relates to a blow box apparatus which is used in a drying section of a papermaking machine in which a web is disposed between an upstream dryer and a supporting drying felt. The web is guided around a vacuum transfer roll with the drying felt disposed between the web and the transfer roll. Thereafter, the web is guided around a downstream dryer with the web disposed between the downstream dryer and the drying felt. The blow box apparatus according to the present invention is disposed within a pocket defined between the dryers and the transfer roll. The blow box apparatus according to the present invention includes an elongate box which extends in a cross machine direction along the width of the pocket. The box defines an enclosure which has a first and a second end. The first and the second ends of the enclosure are connected to a source of pressurized air. The blow box apparatus includes a first end wall which has a proximal and a distal end and a first and a second edge. The proximal end is secured to the first end of the enclosure and the distal end is disposed adjacent to the transfer roll. The first edge of the first end wall is disposed adjacent to the upstream dryer and the second edge is disposed adjacent to the downstream dryer. The blow box apparatus includes a second end wall which has a further proximal and a further distal end and a further first and a further second edge. The further proximal end is secured to the second end of the enclosure and the further distal end is disposed adjacent to the transfer roll. The further first edge is disposed adjacent to the upstream dryer and the further second edge is disposed adjacent to the downstream dryer. The arrangement is such that the box, the end walls, the dryers and the transfer roll defined therebetween a chamber which extends in a cross machine direction. The box defines a slot which extends in the cross machine direction between the first and the second ends of the enclosure so that in use of the apparatus, pressurized air within the enclosure flows from the enclosure through the slot for generating a partial vacuum within the chamber. A baffle is disposed between the end walls and extends from the box towards the transfer roll for dividing the chamber into a main cavity and a threading cavity. The arrangement is such that during a threading operation, a tail of the web is guided around the upstream dryer and around a threading chamber of the transfer roll with the threading chamber disposed adjacent to the threading cavity. Thereafter, the web is guided around the downstream dryer so that dissipation of vacuum generated within the threading chamber through the main cavity is inhibited by the baffle. Accordingly, the tail is positively urged towards the threading chamber for assisting threading of the tail. Also, subsequent to threading of the tail, the tail is widened to the full width of the web such that vacuum within both the threading cavity and the main cavity assists in inhibiting web flutter.

In a more specific embodiment of the present invention, the elongate box includes a top wall having a first and a second extremity and an upstream and a downstream end.

An upstream wall is disposed adjacent to the upstream dryer and extends from the upstream end of the top wall towards the transfer roll.

Also, a downstream wall is disposed adjacent to the downstream dryer and extends from the downstream end of the top wall towards the transfer roll.

Furthermore, a bottom wall has a first and a second termination and an upstream and a downstream extremity. The bottom wall extends from the upstream wall to the downstream wall, the bottom wall being spaced relative to the top wall.

Additionally, a first side wall is secured to the top, upstream, downstream and bottom walls.

A second side wall is secured to the top, upstream, downstream and bottom walls such that the top, upstream, downstream, bottom, first side and second side walls define therebetween the enclosure.

Moreover, the first side wall defines a first opening which is connected to the source of pressurized air. Also, the second side wall defines a second opening which is connected to the source of pressurized air.

The first end wall is secured to and extends away from the first side wall of the box towards the transfer roll.

Furthermore, the second end wall is secured to and extends away from the second side wall of the box towards the transfer roll.

The first side wall of the box defines a first slit such that in use of the apparatus, pressurized air flows outwardly from the enclosure through the first slit for generating a low air pressure zone in a vicinity of an edge of the web moving from the upstream dryer to the transfer roll for reducing edge flutter of the web.

Additionally, the first side wall of the box also defined a second slit such that in use of the apparatus, pressurized air flows outwardly from the enclosure through the second slit for generating a further low air pressure zone in a vicinity of an edge of the web moving from the transfer roll to the downstream dryer for reducing edge flutter of the web.

Also, the second side wall of the box defines a first elongate nozzle such that in use of the apparatus, pressurized air flows outwardly from the enclosure through the first elongate nozzle for generating a reduced air pressure zone in a vicinity of a further edge of the web moving from the upstream dryer to the transfer roll for reducing edge flutter of the web.

Moreover, the second side wall of the box also defines a second elongate nozzle such that in use of the apparatus, pressurized air flows outwardly from the enclosure through the second elongate nozzle for generating a further reduced air pressure zone in a vicinity of the further edge of the web moving from the transfer roll to the downstream dryer for reducing edge flutter of the web.

The slot of the box is configured such that a Coanda effect partial vacuum is generated within the chamber.

Also, the baffle is disposed within a cross machine direction distance from the first end wall within a range 20 to 40 inches.

In a preferred embodiment of the present invention, the baffle is a fixed baffle which is secured to the bottom wall of the box.

The baffle is disposed spaced from and parallel to the first and second end walls.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a perspective view of part of a dryer section of a papermaking machine which includes a blow box apparatus according to the present invention;

FIG. 2 is a side elevational view of the box shown in FIG. 1 when viewed from the downstream dryer towards the upstream dryer;

FIG. 3 is an enlarged view taken on the line 3-3 of FIG. 2;

FIG. 4 is an enlarged view taken on the line 4-4 of FIG. 2; and

FIG. 5 is a similar view to that shown in FIG. 2 but shows a threading operation.

Similar reference characters refer to similar parts throughout the various views of the drawings.

### DETAILED DESCRIPTION OF THE DRAWINGS

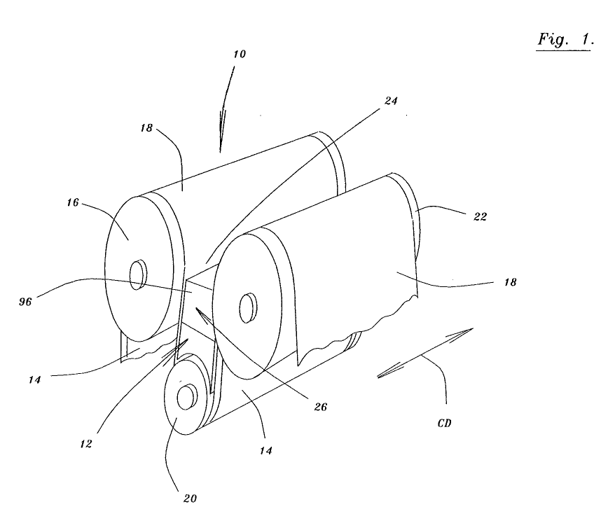

FIG. 1 is a perspective view of part of a dryer section generally designated 10 of a papermaking machine which includes a blow box apparatus generally designated 12 according to the present invention. As shown in FIG. 1, a web 14 is disposed between an upstream dryer 16 and a supporting drying felt 18. The web 14 and felt 18 are guided around a vacuum transfer roll 20 with the drying felt 18 disposed between the web 14 and the transfer roll 20. Thereafter, the web 14 is guided around a downstream dryer 22 with the web 14 disposed between the downstream dryer 22 and the drying felt 18. The blow box apparatus 12 is disposed within a pocket 24 defined between the dryers 16 and 22 and the transfer roll 20. The blow box apparatus 12 includes an elongate box generally designated 26 which extends in a cross machine direction CD along the pocket 24.

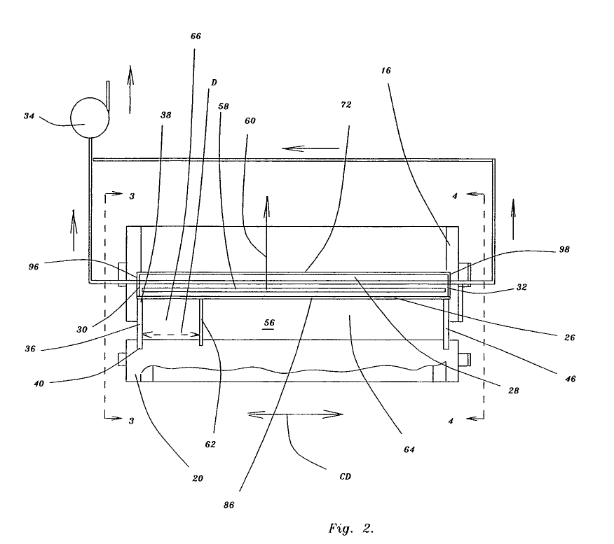

FIG. 2 is a side elevational view of the box 26 shown in FIG. 1 when viewed from the downstream dryer towards the upstream dryer. As shown in FIG. 2, the box 26 defined an enclosure 28 which has a first and a second end 30 and 32 respectively. The first and the second ends 30 and 32 respectively of the enclosure 28 are connected to a source of pressurized air 34. A first end wall 36 has a proximal and a distal end 38 and 40 respectively.

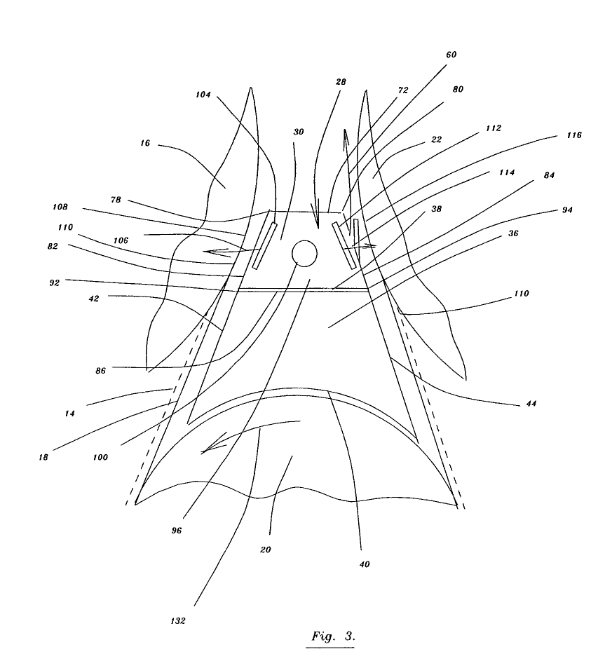

FIG. 3 is an enlarged view taken on the line 3-3 of FIG. 2. As shown in FIG. 3, the first end wall 36 has a first and a second edge 42 and 44 respectively. The proximal end 38 is secured to the first end 30 of the enclosure 28 and the distal end 40 is disposed adjacent to the transfer roll 20. The first edge 42 is disposed adjacent to the upstream dryer 16 and the second edge 44 is disposed adjacent to the downstream dryer 22.

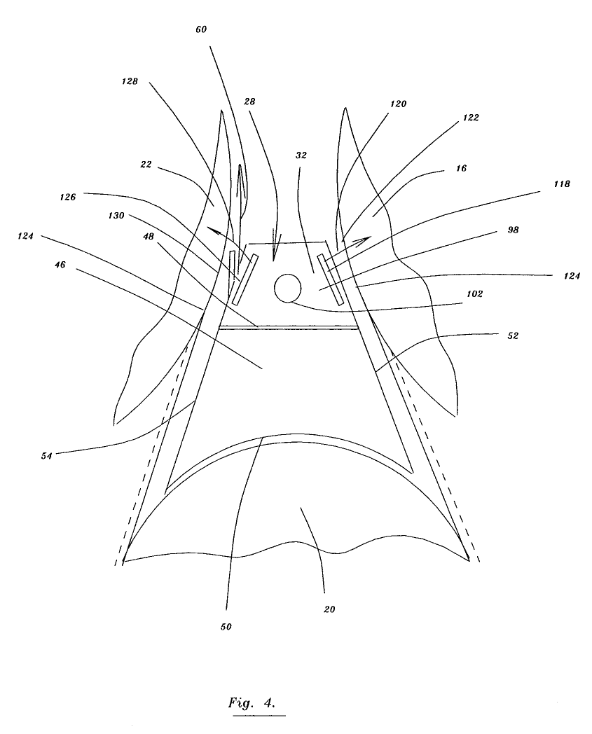

FIG. 4 is an enlarged view taken on the line 44 of FIG. 2. As shown in FIG. 4, a second end wall 46 has a further proximal and a further distal end 48 and 50 respectively and a further first and a further second edge 52 and 54 respectively. The further proximal end 48 is secured to the second end 32 of the enclosure 28 and the further distal end 50 is disposed adjacent to the transfer roll 20. The further first edge 52 is disposed adjacent to the upstream dryer 16 and the further second edge 54 is disposed adjacent to the downstream dryer 22.

As shown in FIG. 2, the arrangement is such that the box 26, the end walls 36 and 46, the dryers 16 and 22 and the transfer roll 20 defined therebetween a chamber 56 which extends in the cross machine direction CD. The box 26 defines a slot 58 which extends in the cross machine direction CD between the first and the second ends 30 and 32 respectively of the enclosure 28 such that in use of the apparatus 12, pressurized air within the enclosure 28 flows, as indicated by the arrow 60, from the enclosure 28 through the slot 58 for generating a partial vacuum within the chamber 56. A baffle 62 is disposed between the end walls 36 and 46 and extends from the box 26 towards the transfer roll 20 for dividing the chamber 56 into a main cavity 64 and a threading cavity 66.

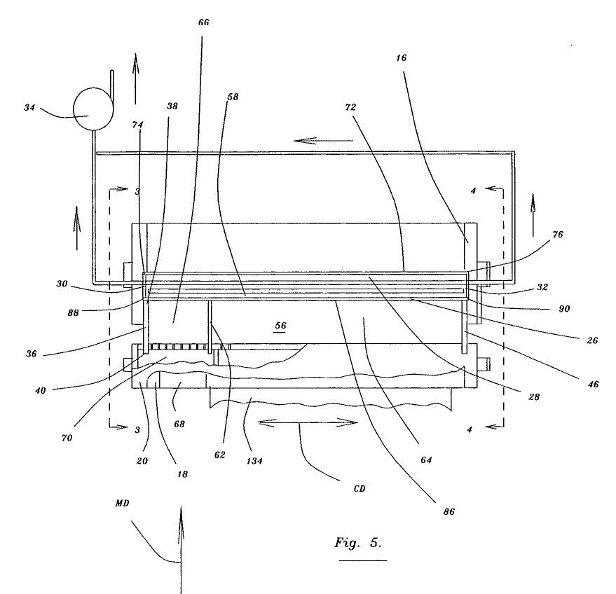

FIG. 5 is a similar view to that shown in FIG. 2 but shows a threading operation. As shown in FIG. 5, a tail 68 of the web 14 is guided around the upstream dryer 16 and around a threading chamber 70 of the transfer roll 20. The threading chamber 70 is disposed adjacent to the threading cavity 66 and the tail 68 is then guided around the downstream dryer 22 so that dissipation of vacuum generated within the threading chamber 70 through the main cavity 64 is inhibited by the baffle 62. Accordingly, the tail 68 is positively urged towards the threading chamber 70 for assisting threading of the tail 68. Also, subsequent to threading of the tail 68, the tail 68 is widened to the full width of the web 14 such that vacuum within both the threading cavity 66 and the main cavity 64 assists in inhibiting web flutter.

As shown in FIG. 5, the elongate box 26 includes a top wall 72 having a first and a second extremity 74 and 76 respectively.

As shown in FIG. 3, the top wall 72 has an upstream and a downstream end 78 and 80 respectively. An upstream wall 82 is disposed adjacent to the upstream dryer 16 and extends from the upstream end 78 of the top wall 72 towards the transfer roll 20.

Also, a downstream wall 84 is disposed adjacent to the downstream dryer 22 and extends from the downstream end 80 of the top wall 72 towards the transfer roll 20.

Furthermore, a bottom wall 86 has a first and a second termination 88 and 90 respectively as shown in FIG. 5 and an upstream and a downstream extremity 92 and 94 respectively as shown in FIG. 3.

As shown in FIG. 3, the bottom wall 86 extends from the upstream wall 82 to the downstream wall 84, the bottom wall 86 being spaced relative to the top wall 72.

Additionally, as shown in FIG. 2, a first side wall 96 is secured to the top, upstream, downstream and bottom walls 72, 82, 84 and 86 respectively.

A second side wall 98 is secured to the top wall 72, upstream wall 82, downstream wall 84 and bottom wall 86 such that the top wall 72, upstream wall 82, downstream wall 84, bottom wall 86, first side wall 96 and second side wall 98 defined therebetween the enclosure 28.

As shown in FIG. 3, the first side wall 96 defines a first opening 100 which is connected to the source of pressurized air 34.

As shown in FIG. 4, the second side wall 98 defines a second opening 102 which is also connected to the source of pressurized air 34.

As shown in FIG. 3, the first end wall 36 is secured to and extends away from the first side wall 96 of the box 26 towards the transfer roll 20.

As shown in FIG. 4, the second end wall 46 is secured to and extends away from the second side wall 98 of the box 26 towards the transfer roll 20.

As shown in FIG. 3, the first side wall 96 of the box 26 defines a first slit 104 such that in use of the apparatus, 12, pressurized air flows outwardly as indicated by the arrow 106 from the enclosure 28 through the first slit 104 for generating a low air pressure zone 108 in a vicinity of an edge 110 of the web 14 moving from the upstream dryer 16 to the transfer roll 20 for reducing edge flutter of the web 14.

Additionally, the first side wall 96 of the box 26 also defined a second slit 112 such that in use of the apparatus 12, pressurized air flows outwardly as indicated by the arrow 114 from the enclosure 28 through the second slit 112 for generating a further low air pressure zone 116 in a vicinity of the edge 110 of the web 14 moving from the transfer roll 20 to the downstream dryer 22 for reducing edge flutter of the web 14.

As shown in FIG. 4, the second side wall 98 of the box 26 defines a first elongate nozzle 118 such that in use of the apparatus 12, pressurized air flows outwardly as indicated by the arrow 120 from the enclosure 28 through the first elongate nozzle 118 for generating a reduced air pressure zone 122 in a vicinity of a further edge 124 of the web 14 moving between the upstream dryer 16 and the transfer roll 20 for reducing edge flutter of the web 14.

Moreover, the second side wall 98 of the box 26 also defines a second elongate nozzle 126 such that in use of the apparatus 12, pressurized air flows outwardly as indicated by the arrow 128 from the enclosure 28 through the second elongate nozzle 126 for generating a further reduced air pressure zone 130 in a vicinity of the further edge 124 of the web 14 moving from the transfer roll 20 to the downstream dryer 22 for reducing edge flutter of the web 14.

As shown in FIG. 2, the slot 58 is configured such that a Coanda effect partial vacuum is generated within the chamber 56.

Also, the baffle 62 is disposed within a cross machine directional distance D from the first end wall 36 within a range 20 to 40 inches.

In a preferred embodiment of the present invention, the baffle 62 is a fixed baffle which is secured to the bottom wall 86 of the box 26.

In operation of the apparatus 12 according to the present invention, a tail 68 of the web 14 is cut in a machine direction MD, as shown in FIG. 5. Vacuum is applied to each threading chamber 70 of each transfer roll 20 of the drying section 10. Accordingly, as shown in FIGS. 3 and 5, the tail 68 is automatically threaded between the drying felt 18 and the upstream dryer 16 which is rotated as indicated by the arrow 132 at slow speed so that the tail 68 is urged by the vacuum within the threading chamber 70 against the felt 18 as the tail 68 moves around the threading chamber 70 and onto the downstream dryer 22 where the tail 68 is disposed between the felt 18 and the downstream dryer 22.

As shown in FIG. 5, the remainder 134 of the full width web 14 is returned to a broke pit, (not shown) disposed beneath the dryer section 10, during the automatic threading operation. When the tail 68 has been successfully threaded through the entire length of the drying section 10 and movement of the tail 68 through the drying section 10 has been stabilized, the tail 68 is widened to a full width of the web 14. In practice, the tail 68 becomes widened by a diagonal cut in the web 14 until the entire width of the web 14 has been threaded through the dryer section 10 and has been stabilized. When the full width web 14 has been stabilized, the rotational speed of the dryers 16 and 22 is gradually increased to a high speed drying speed.

During the slow speed tail threading operation, the vacuum applied within the threading chamber 70 of the transfer roll is confined within the threading chamber 70 of the transfer roll 20 and the threading cavity 66 of the blow box apparatus 12. The baffle 62 within the blow box apparatus 12 prevents dissipation of such vacuum into the main cavity 64 of the blow box apparatus 12. During the slow speed tail threading operation, it is preferable that no vacuum be applied to either the threading cavity 66 or the main cavity 64.

However, when the drying section 10 is operating at high speed during a drying operation, vacuum is generated within both the threading cavity 66 and the main cavity 64 and such vacuum assists in reducing edge flutter of the web 14.

The present invention provides a unique arrangement for inhibiting dissipation of vacuum from a threading chamber of a transfer roll during a threading operation.

What is claimed is:

1. In a dryer section of a papermaking machine in which a web disposed between an upstream dryer and a supporting drying felt is guided around a vacuum transfer roll with the drying felt disposed between the web and the transfer roll and in which the web is thereafter guided around a downstream dryer with the web disposed between the downstream dryer and the drying felt, a blow box apparatus disposed within a pocket defined between the dryers and the transfer roll, said blow box apparatus comprising:
an elongate box extending in a cross machine direction along the pocket, said box defining an enclosure having a first and a second end, said first end and said second end of said enclosure being connected to a source of pressurized air;
a first end wall having a proximal and a distal end and a first and a second edge, said proximal end being secured to said first end of said enclosure, said distal end being disposed adjacent to the transfer roll, said first edge being disposed adjacent to the upstream dryer and said second edge being disposed adjacent to the downstream dryer;
a second end wall having a further proximal and a further distal end and a further first and a further second edge, said further proximal end being secured to said second end of said enclosure, said further distal end being disposed adjacent to the transfer roll, said further first edge being disposed adjacent to the upstream dryer and said further second edge being disposed adjacent to the downstream dryer such that said box, said end walls, the dryers and the transfer roll define therebetween a chamber extending in a cross machine direction; and
said box defining a slot which extends in said cross machine direction between said first and said second ends of said enclosure such that in use of the apparatus, pressurized air within said enclosure flows from said enclosure through said slot for generating a partial vacuum within said chamber; and
a baffle disposed between said end walls and extending from said box towards the transfer roll for dividing said chamber into a main cavity and a threading cavity, the arrangement being such that during a threading operation, a tail of the web is guided around the upstream dryer and around a threading chamber of the transfer roll, the threading chamber being disposed adjacent to said threading cavity, the web being then guided around the downstream dryer so that dissipation of vacuum generated within the threading chamber through said main cavity is inhibited by said baffle such that the tail is positively urged towards the threading chamber for assisting threading of the tail and so that subsequent to threading the tail, the tail is widened to the full width of the web such that vacuum within both said threading cavity and said main cavity assists in inhibiting web flutter.

2. A blow box apparatus as set forth in claim 1 wherein
said elongate box includes:
a top wall having a first and a second extremity and an upstream and a downstream end;
an upstream wall disposed adjacent to the upstream dryer and extending from said top wall towards the transfer roll;
a downstream wall disposed adjacent to the downstream dryer and extending from said top wall towards the transfer roll;
a bottom wall having a first and a second termination and an upstream and a downstream extremity, said bottom wall extending from said upstream wall to said downstream wall, said bottom wall being spaced relative to said top wall;
a first side wall secured to said top, upstream, downstream and bottom walls;
a second side wall secured to said top, upstream, downstream and bottom walls such that said top, upstream, downstream, bottom, first side and second side walls define therebetween said enclosure.

3. A blow box apparatus as set forth in claim 2 wherein
said first side wall defines a first opening which is connected to the source of pressurized air;
said second side wall defines a second opening which is connected to the source of pressurized air.

4. A blow box apparatus as set forth in claim 3 wherein
said first end wall is secured to and extends away from said first side wall of said box towards the transfer roll;
said second end wall is secured to and extends away from said second side wall of said box towards the transfer roll.

5. A blow box apparatus as set forth in claim 4 wherein
said first side wall of said box defines a first slit such that in use of the apparatus, pressurized air flows outwardly from said enclosure through said first slit for generating a low air pressure zone in a vicinity of an edge of the web moving between the upstream dryer and the transfer roll for reducing edge flutter of the web;
said first side wall of said box also defining a second slit such that in use of the apparatus, pressurized air flows outwardly from said enclosure through said second slit for generating a further low air pressure zone in a vicinity of an edge of the web moving between the transfer roll and the downstream dryer for reducing edge flutter of the web;
said second side wall of said box defining a first elongate nozzle such that in use of the apparatus, pressurized air flows outwardly from said enclosure through said first elongate nozzle for generating a reduced air pressure zone in a vicinity of a further edge of the web moving between the upstream dryer and the transfer roll for reducing edge flutter of the web;
said second side wall of said box also defining a second elongate nozzle such that in use of the apparatus, pressurized air flows outwardly from said enclosure through said second elongate nozzle for generating a further reduced air pressure zone in a vicinity of the further edge of the web moving between the transfer roll and the downstream dryer for reducing edge flutter of the web.

6. A blow box apparatus as set forth in claim 1 wherein
said slot is configured such that a Coanda effect partial vacuum is generated within said chamber.

7. A blow box apparatus as set forth in claim 1 wherein
said baffle is disposed within a cross machine directional distance from said first end wall within a range 20 to 40 inches.

8. A blow box apparatus as set forth in claim 2 wherein
said baffle is a fixed baffle which is secured to said bottom wall of said box.

9. A blow box apparatus as set forth in claim 1 wherein
said baffle is disposed spaced from and parallel to said first and second end walls.

10. In a dryer section of a papermaking machine in which a web disposed between an upstream dryer and a supporting drying felt is guided around a vacuum transfer roll with the drying felt disposed between the web and the transfer roll and in which the web is thereafter guided around a downstream dryer with the web disposed between the downstream dryer and the drying felt, a blow box apparatus disposed within a pocket defined between the dryers and the transfer roll, said blow box apparatus comprising:
an elongate box extending in a cross machine direction along the pocket, said box defining an enclosure having a first and a second end, said first end and said second end of said enclosure being connected to a source of pressurized air;
a first end wall having a proximal and a distal end and a first and a second edge, said proximal end being secured to said first end of said enclosure, said distal end being disposed adjacent to the transfer roll, said first edge being disposed adjacent to the upstream dryer and said second edge being disposed adjacent to the downstream dryer;
a second end wall having a further proximal and a further distal end and a further first and a further second edge, said further proximal end being secured to said second end of said enclosure, said further distal end being disposed adjacent to the transfer roll, said further first edge being disposed adjacent to the upstream dryer and said further second edge being disposed adjacent to the downstream dryer such that said box, said end walls, the dryers and the transfer roll define therebetween a chamber extending in a cross machine direction;
said box defining a slot which extends in said cross machine direction between said first and said second ends of said enclosure such that in use of the apparatus, pressurized air within said enclosure flows from said enclosure through said slot for generating a partial vacuum within said chamber; and
a baffle disposed between said end walls and extending from said box towards the transfer roll for dividing said chamber into a main cavity and a threading cavity, the arrangement being such that during a threading operation, a tail of the web is guided around the upstream dryer and around a threading chamber of the transfer roll, the threading chamber being disposed adjacent to said threading cavity, the web being then guided around the downstream dryer so that dissipation of vacuum generated within the threading chamber through said main cavity is inhibited by said baffle such that the tail is positively urged towards the threading chamber for assisting threading of the tail and so that subsequent to threading the tail, the tail is widened to the full width of the web such that vacuum within both said threading cavity and said main cavity assists in inhibiting web flutter;
said box including a bottom wall;
said baffle being a fixed baffle which is secured to said bottom wall of said box; and
said baffle being disposed spaced from and parallel to said first and second end walls.

11. In a dryer section of a papermaking machine in which a web disposed between an upstream dryer and a supporting drying felt is guided around a vacuum transfer roll with the drying felt disposed between the web and the transfer roll and in which the web is thereafter guided around a downstream dryer with the web disposed between the downstream dryer and the drying felt, a blow box apparatus disposed within a pocket defined between the dryers and the transfer roll, said blow box apparatus comprising:
an elongate box extending in a cross machine direction along the pocket, said box defining an enclosure having a first and a second end, said first end and said second end of said enclosure being connected to a source of pressurized air;
a first end wall having a proximal and a distal end and a first and a second edge, said proximal end being secured to said first end of said enclosure, said distal end being disposed adjacent to the transfer roll, said first edge being disposed adjacent to the upstream dryer and said second edge being disposed adjacent to the downstream dryer;
a second end wall having a further proximal and a further distal end and a further first and a further second edge, said further proximal end being secured to said second end of said enclosure, said further distal end being disposed adjacent to the transfer roll, said further first edge being disposed adjacent to the upstream dryer and said further second edge being disposed adjacent to the downstream dryer such that said box, said end walls, the dryers and the transfer roll define therebetween a chamber extending in a cross machine direction;
said box defining a slot which extends in said cross machine direction between said first and said second ends of said enclosure such that in use of the apparatus, pressurized air within said enclosure flows from said enclosure through said slot for generating a partial vacuum within said chamber; and
a baffle disposed between said end walls and extending from said box towards the transfer roll for dividing said chamber into a main cavity and a threading cavity, the arrangement being such that during a threading operation, a tail of the web is guided around the upstream dryer and around a threading chamber of the transfer roll, the threading chamber being disposed adjacent to said threading cavity, the web being then guided around the downstream dryer so that dissipation of vacuum generated within the threading chamber through said main cavity is inhibited by said baffle such that the tail is positively urged towards the threading chamber for assisting threading of the tail and so that subsequent to threading the tail, the tail is widened to the full width of the web such that vacuum within both said threading cavity and said main cavity assists in inhibiting web flutter;
said elongate box including:
a top wall having a first and a second extremity and an upstream and a downstream end;
an upstream wall disposed adjacent to the upstream dryer and extending from said top wall towards the transfer roll;
a downstream wall disposed adjacent to the downstream dryer and extending from said top wall towards the transfer roll;
a bottom wall having a first and a second termination and an upstream and a downstream extremity, said bottom wall extending from said upstream wall to said downstream wall, said bottom wall being spaced relative to said top wall;
a first side wall secured to said top, upstream, downstream and bottom walls;
a second side wall secured to said top, upstream, downstream and bottom walls such that said top, upstream, downstream, bottom, first side and second side walls define therebetween said enclosure;
said first side wall defining a first opening which is connected to the source of pressurized air;
said second side wall defining a second opening which is connected to the source of pressurized air;
said first end wall being secured to and extending away from said first side wall of said box towards the transfer roll;
said second end wall being secured to and extending away from said second side wall of said box towards the transfer roll;
said first side wall of said box defining a first slit such that in use of the apparatus, pressurized air flows outwardly from said enclosure through said first slit for generating a low air pressure zone in a vicinity of an edge of the web moving between the upstream dryer and the transfer roll for reducing edge flutter of the web;
said first side wall of said box also defining a second slit such that in use of the apparatus, pressurized air flows outwardly from said enclosure through said second slit for generating a further low air pressure zone in a vicinity of the edge of the web moving between the transfer roll and the downstream dryer for reducing edge flutter of the web;
said second side wall of said box defining a first elongate nozzle such that in use of the apparatus, pressurized air flows outwardly from said enclosure through said first elongate nozzle for generating a reduced air pressure zone in a vicinity of a further edge of the web moving between the upstream dryer and the transfer roll for reducing edge flutter of the web;
said second side wall of said box also defining a second elongate nozzle such that in use of the apparatus, pressurized air flows outwardly from said enclosure through said second elongate nozzle for generating a further reduced air pressure zone in a vicinity of the further edge of the web moving between the transfer roll and the downstream dryer for reducing edge flutter of the web;
said slot being configured such that a Coanda effect partial vacuum is generated within said chamber;
said baffle being disposed within a cross machine directional distance from said first end wall within a range 25 to 35 inches;
said baffle being a fixed baffle which is secured to said bottom wall of said box; and
said baffle being disposed spaced from and parallel to said first and second end walls.
